(19) United States
(12) Patent Application Publication
(10) Pub. No.: US 2015/0301649 A1
(43) Pub. Date: Oct. 22, 2015

(54) TOUCH SENSING APPARATUS AND TOUCHSCREEN APPARATUS INCLUDING THE SAME

(71) Applicant: Samsung Electro-Mechanics Co., Ltd., Suwon (KR)

(72) Inventors: Su Jong KIM, Suwon (KR); Ji Hoon KIM, Suwon (KR); Yoon Seok OH, Suwon (KR); Do Sang KWON, Suwon (KR); Hyun Suk LEE, Suwon (KR); Sang Hyun SIM, Suwon (KR)

(73) Assignee: Samsung Electro-Mechanics Co., Ltd., Suwon (KR)

(21) Appl. No.: 14/486,489

(22) Filed: Sep. 15, 2014

(30) Foreign Application Priority Data
Apr. 18, 2014 (KR) 10-2014-0046692

(51) Int. Cl. G06F 3/044

(52) U.S. Cl. CPC G06F 3/044

(57) ABSTRACT

A touch sensing apparatus may include a noise removing unit removing noise components from digital signals generated based on changes in capacitance; an edge extracting unit extracting edges of the digital signals; a calculating unit calculating an output signal of the noise removing unit and the edges output from the edge extracting unit; and a touch determining unit determining a touch based on an output signal of the calculating unit.

### CROSS-REFERENCE TO RELATED APPLICATION

This application claims the benefit of Korean Patent Application No. 10-2014-0046692 filed on Apr. 18, 2014, with the Korean Intellectual Property Office, the disclosure of which is incorporated herein by reference.

### BACKGROUND

The present disclosure relates to a touch sensing apparatus and a touchscreen apparatus including the same.

In general, a touchscreen apparatus such as a touchscreen, a touch pad, or the like, a user interface device attached to a display apparatus to provide an intuitive device interface method to a user, has recently been widely used in various electronic apparatuses such as cellular phones, personal digital assistants (PDAs), navigation apparatuses, and the like. Particularly, as demand for smartphones has recently increased, the use of touchscreens, as touch apparatuses capable of providing various device interface methods in a limited form factor has correspondingly increased.

Touchscreens used in portable apparatuses may mainly be divided into resistive type touchscreens and capacitive type touchscreens, according to a method of sensing a touch implemented therein. Here, capacitive type touchscreens have advantages in that a relatively long lifespan and various interface methods, such as hand gestures may be provided thereby, such that the use thereof has increased. Particularly, capacitive type touchscreens may more easily for allow for multi-touch device interactions, as compared with resistive type touchscreens, such that capacitive type touchscreens are currently widely used in apparatuses such as smartphones, and the like.

Capacitive type touchscreens commonly include a plurality of electrodes having a predetermined pattern and defining a plurality of nodes in which changes in capacitance are generated by a touch. In the plurality of nodes distributed on a two-dimensional plane, changes in self-capacitance or in mutual-capacitance are generated by the touch. Coordinates of the touch may be calculated by applying a weighted average method, or the like, to the changes in capacitance generated in the plurality of nodes.

In order to for the touchscreens to precisely detect touches, noise introduced into the touchscreen apparatus should be effectively removed. However, in the case in which a noise filter is uniformly used for low level data points, loss of such low level data points may occur. Therefore, even in the case in which the noise filter is used, low level data points need to be reserved.

### RELATED ART DOCUMENT

(Patent Document 1) Korean Patent Laid-Open Publication No. 2010-0095126

### SUMMARY

An exemplary embodiment in the present disclosure may provide a touch sensing apparatus and a touchscreen apparatus capable of reflecting edges of digital signals to digital signals from which noise components have been removed.

According to an exemplary embodiment in the present disclosure, a touch sensing apparatus may include: a noise removing unit removing noise components from digital signals generated based on changes in capacitance; an edge extracting unit extracting edges of the digital signals; a calculating unit calculating an output signal of the noise removing unit and the edges output from the edge extracting unit; and a touch determining unit determining a touch input based on an output signal of the calculating unit.

The noise removing unit may remove noise components, distributed in a Gaussian form, from the digital signal.

The edge extracting unit may detect an envelope of the digital signal to extract the edges.

The calculating unit may perform an averaging operation for the output signal of the noise removing unit and the edges.

The calculating unit may perform the averaging operation by assigning different weights to the output signal of the noise removing unit and the edges.

The touch determining unit may determine at least one of the number, coordinates, and gesture operations of touches.

According to an exemplary embodiment in the present disclosure, touchscreen apparatus may include: a panel unit including a plurality of first electrodes and a plurality of second electrodes intersecting with the plurality of first electrodes; and a touch sensing unit sensing a touch based on digital signals generated according to levels of capacitance in intersection points of the plurality of first electrodes and the plurality of second electrodes, wherein the touch sensing unit determines the touch by calculating a first signal that noise components have been removed from the digital signals and a second signal along edges of the digital signals.

The touch sensing unit may include: a noise removing unit removing noise components from the digital signals to generate the first signal; an edge extracting unit extracting the edges of the digital signal to generate the second signal; a calculating unit calculating the first signal and the second signal; and a touch determining unit determining the touch based on an output signal of the calculating unit.

The noise removing unit may remove noise components, distributed in a Gaussian form, from the digital signal.

The edge extracting unit may detect an envelope of the digital signal to extract the edges.

The calculating unit may perform an averaging operation for the first signal and the second signal.

The calculating unit may perform the averaging operation by assigning different weights to the first signal and the second signal.

The touchscreen apparatus may further include a driving circuit unit applying a predetermined driving signal to the plurality of first electrodes.

The touchscreen apparatus may further include a sensing circuit unit detecting the levels of capacitance from the plurality of second electrodes.

The touchscreen apparatus may further include a signal converting unit performing an analog-digital conversion for the levels of capacitance to generate the digital signals.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an exterior of an electronic device including a touchscreen apparatus according to an exemplary embodiment in the present disclosure;

FIG. 2 is a view illustrating a panel unit that may be included in the touchscreen apparatus according to an exemplary embodiment in the present disclosure;

FIG. 3 is a view illustrating a cross-section of the panel unit that may be included in the touchscreen apparatus according to an exemplary embodiment in the present disclosure;

FIG. 4 is a view illustrating a touchscreen apparatus according to an exemplary embodiment in the present disclosure;

FIG. 5 is a block diagram illustrating a touch sensing unit according to an exemplary embodiment in the present disclosure; and

FIG. 6 is a view illustrating a digital signal according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

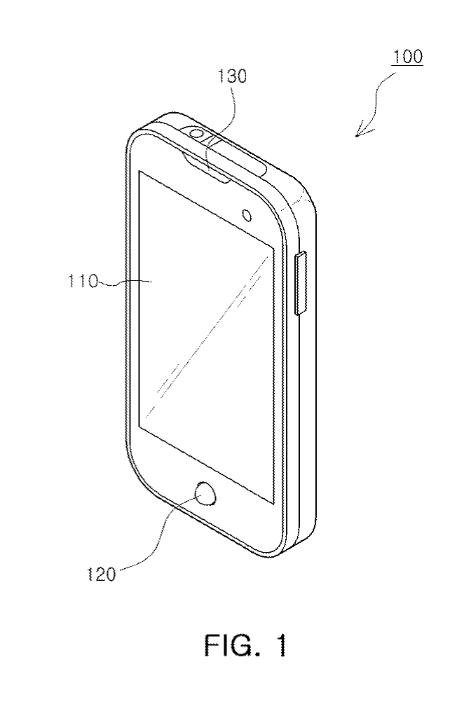

FIG. 1 is a perspective view illustrating an exterior of an electronic device including a touchscreen apparatus according to an exemplary embodiment in the present disclosure.

Referring to FIG. 1, an electronic device 100 according to the present exemplary embodiment may include a display apparatus 110 for outputting a screen, an input unit 120, an audio unit 130 for outputting an audio, and a touch sensing apparatus integrated with the display apparatus 110.

As illustrated in FIG. 1, in the case of a mobile device, the touch sensing apparatus may be generally integrated with the display apparatus and needs to have a high degree of light transmissivity to which an image passes through a screen displayed on the display apparatus. Therefore, the touch sensing apparatus may be implemented by forming an electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephtalate (PET), polycarbonate (PC), polyethersulfone (PES), polyimide (PI), a polymethyl methacrylate (PMMA), or the like. In addition, the electrode may be formed of fine conductive lines formed of anyone of silver (Ag), aluminum (Al), chrome (Cr), nickel (Ni), molybdenum (Mo), and copper (Cu), or an alloy thereof.

The display apparatus may include a wiring pattern disposed on a bezel region thereof, wherein the wiring pattern is connected to the electrode. Since the wiring pattern is visually shielded by the bezel region, it may also be formed of a metal material such as silver (Ag), copper (Cu), or the like.

The touchscreen apparatus according to an exemplary embodiment in the present disclosure may be a capacitive type touchscreen apparatus and accordingly, it may include a plurality of electrodes having a predetermined pattern. Also, the touchscreen apparatus according to an embodiment in the present disclosure may include a capacitance detection circuit detecting changes in capacitance generated in the plurality of electrodes, an analog-to-digital conversion circuit converting an output signal from the capacitance detection circuit into a digital value, an operation circuit determining a touch by using data converted as the digital value, and the like.

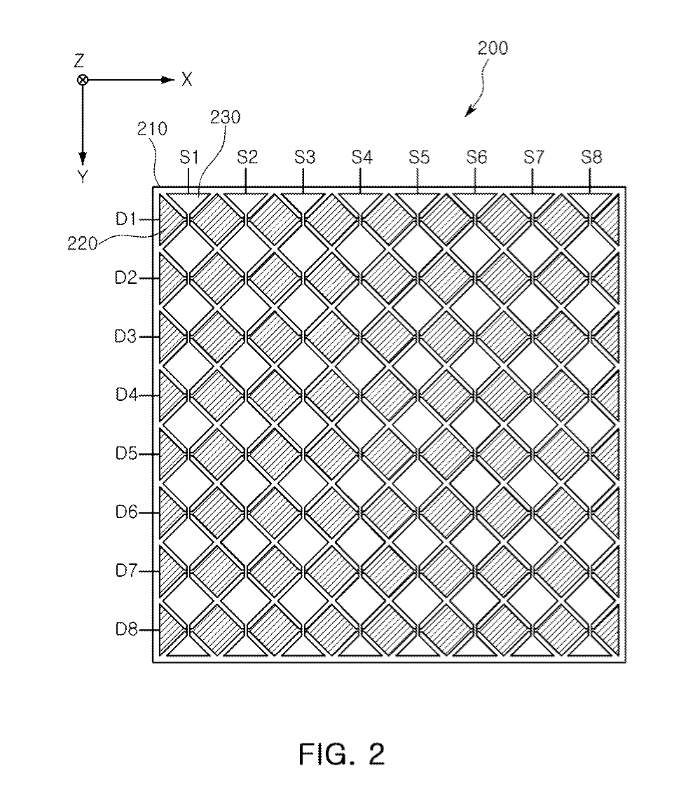

FIG. 2 is a view illustrating a panel unit that may be included in the touchscreen apparatus according to an exemplary embodiment in the present disclosure.

Referring to FIG. 2, the panel unit 200 according to the present exemplary embodiment may include a substrate 210 and a plurality of electrodes 220 and 230 provided on the substrate 210. Although not illustrated in FIG. 2, each of the plurality of electrodes 220 and 230 may be electrically connected to a wiring pattern of a circuit substrate attached to one end of the substrate 210 through wirings and a bonding pad. A controller integrated circuit (a controlling unit) is mounted on the circuit board to detect a sensing signal generated in the plurality of electrodes 220 and 230 and determine a touch from the sensing signal.

The plurality of electrodes 220 and 230 may be provided on one surface or both surfaces of the substrate 210. Although FIG. 2 shows a case in which the plurality of electrodes 220 and 230 have a rhomboid pattern or a diamond pattern, the plurality electrodes 220 and 230 may also have various polygonal patterns such as rectangular patterns, triangular patterns, or the like in addition to the above-mentioned patterns.

The plurality of electrodes 220 and 230 may include first electrodes 220 extending in an X axis direction and second electrodes 230 extending in a Y axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

Further, in addition to a region in which the plurality of electrodes 220 and 230 are formed, with respect to a region in which the wirings connected to the plurality of electrodes 220 and 230 are provided, a predetermined printed region for visually shielding the wiring generally formed of an opaque metal material may be formed on the substrate 210.

The apparatus electrically connected to the plurality of electrodes 220 and 230 to sense a touch may detect changes in capacitance generated in the plurality of electrodes 220 and 230 according to a touch applied thereto and sense the touch therefrom. The first electrode 220 may be connected to channels D1 to D8 in the controller integrated circuit to thereby have a predetermined driving signal applied thereto, and the second electrodes 230 may be connected to channels S1 to S8 to thereby be used for the touch sensing apparatus to detect sensing signals. In this case, the controller integrated circuit may detect the change in mutual-capacitance generated between the first electrode 220 and the second electrode 230 as the sensing signals.

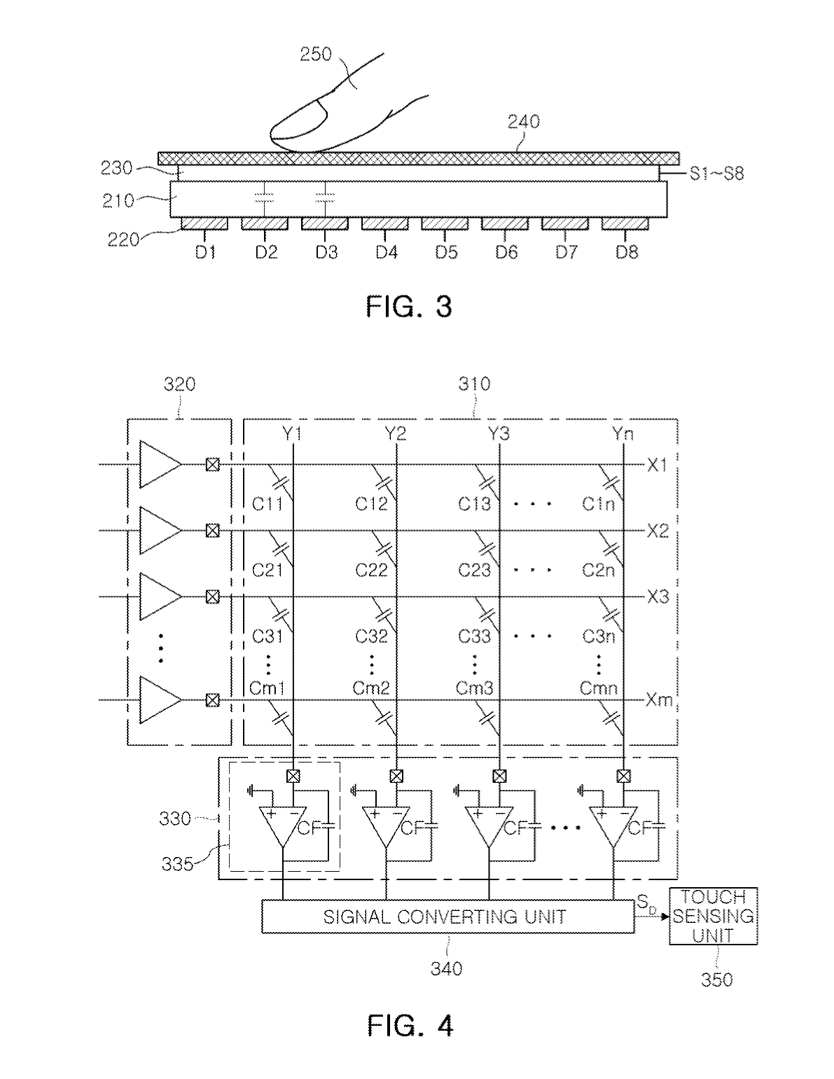

FIG. 3 is a view illustrating a cross-section of the panel unit that may be included in the touchscreen apparatus according to an exemplary embodiment in the present disclosure. FIG. 3 is a cross-sectional view of the panel unit 200 of FIG. 2 taken along a Y-Z plane. The panel unit 200 may further include a cover lens 240 to which a touch is applied, in addition to the substrate 210 and the plurality of sensing electrodes 220 and 230 described with reference to FIG. 2. The cover lens 240 may be provided on the second electrode 230 used to detect the sensing signal and receive a touch applied from a touch object 250 such as a finger, or the like.

When the driving signals are applied to the first electrodes 220 through the channels D1 to D8, mutual capacitance may be generated between the first electrodes 220 to which the driving signals are applied and the second electrodes 230. When the touch object 250 touches the cover lens 240, a capacitance change may be generated in the mutual capacitance generated between the first and second electrodes 220 and 230 that are adjacent to a region touched by the touch object 250. The capacitance change may be in proportion to the touch object 250 and an area of an overlapped region between the first electrodes 220 to which the driving signals are applied and the second electrode 230. In FIG. 3, the mutual capacitance generated between the first and second electrodes 220 and 230 connected to the channels D2 and D3, respectively, may be affected by the touch object 250.

FIG. 4 is a view illustrating a touchscreen apparatus according to an exemplary embodiment in the present disclosure.

Referring to FIG. 4, the touchscreen apparatus according to the present exemplary embodiment may include a panel unit 310, a driving circuit unit 320, a sensing circuit unit 330, a signal converting unit 340, and a touch sensing unit 350. In this case, the driving circuit unit 320, the sensing circuit unit 330, the signal converting unit 340, and the touch sensing unit 350 may be implemented in a single integrated circuit (IC).

The panel unit 310 may include a plurality of rows of first electrodes X1 to Xm (driving electrodes) extended in a first axis direction (that is, a horizontal direction of FIG. 4) and a plurality of columns of second electrodes Y1 to Yn (sensing electrodes) extended in a second axis direction (that is, a vertical direction of FIG. 4) intersecting with the first axis. As described above, capacitances may be formed at the intersection points of the plurality of first electrodes X1 to Xm and the plurality of second electrodes Y1 to Yn. Node capacitors C11 to Cmn shown in FIG. 4 show capacitances generated at the intersection points of the plurality of first electrodes X1 to Xm and the plurality of second electrodes Y1 to Yn as capacitor components.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and be sequentially applied to each of the plurality of first electrodes X1 to Xm. Although FIG. 4 shows a case in which circuits for generating and applying the driving signals are individually connected to each of the plurality of first electrodes X1 to Xm, a configuration in which the driving signal is applied to each of the plurality first electrodes X1 to Xm by including a single driving signal generating circuit and using a switching circuit may also be used. In addition, the touchscreen apparatus may be operated in a scheme in which the driving circuit unit 320 concurrently applies the driving signals to all of the first electrodes or selectively applies the driving signals to only a portion of the first electrodes to simply sense whether the touch is present or not.

The sensing circuit unit 330 may detect levels of capacitance in the node capacitors C11 to Cmn from the plurality of second electrodes Y1 to Yn. The sensing circuit unit 330 may include a plurality of C-V converters 335 each including at least one operational amplifier and at least one capacitor, wherein each of the plurality of C-V converters 335 may be connected to the plurality of second electrodes Y1 to Yn.

The plurality of C-V converters 335 may convert the levels of capacitance in the node capacitors C11 to Cmn to voltage signals to output analog signals. As an example, each of the plurality of C-V converters 335 may include an integrating circuit integrating the levels of capacitance. The integrating circuit may integrate the levels of capacitance and convert it to a predetermined voltage to output the predetermined voltage.

Although FIG. 4 shows a configuration of the C-V converter 335 in which a capacitor CF is disposed between an inverse terminal and an output terminal of the operational amplifier, an arrangement of the circuit configuration may also be changed. Further, although FIG. 4 shows a case in which the C-V converter 335 includes one operational amplifier and one capacitor, the C-V converter 335 may include a plurality of operational amplifiers and a plurality of capacitors.

In the case in which the driving signals are sequentially applied to the plurality of first electrodes X1 to Xm, since the levels of capacitance may be concurrently detected from the plurality of second electrodes, the number of C-V converters 335 may correspond to the number n of the plurality of second electrodes Y1 to Yn.

The signal converting unit 340 may generate digital signals S_{D} from the analog signals output from the sensing circuit unit 330. As an example, the signal converting unit 340 may include a time-to-digital converter (TDC) circuit measuring a time in which the analog signal output in a voltage form by the sensing circuit unit 330 arrives at a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the changed amount into the digital signal S_{D}.

The touch sensing unit 350 may determine a touch applied to the panel unit 310 using the digital signals S_{D}. The touch sensing unit 350 may determine the number, coordinates, gesture operations, or the like, of touches applied to the panel unit 310 using the digital signals S_{D}.

The digital signal S_{D} which is the basis for determining the touch by the touch sensing unit 350 may be data digitalizing the changes in capacitance of the node capacitors C11 to Cmn, and particularly, may be data indicating a capacitance difference between a case in which the touch is not generated and a case in which the touch is generated. Typically, in the capacitive type touchscreen apparatus, a region in which the conductive object touches has reduced capacitance as compared with a region in which the touch is not generated. Therefore, the region in which the conductive object touches may indicate the capacitance change larger than the region in which the touch is not generated.

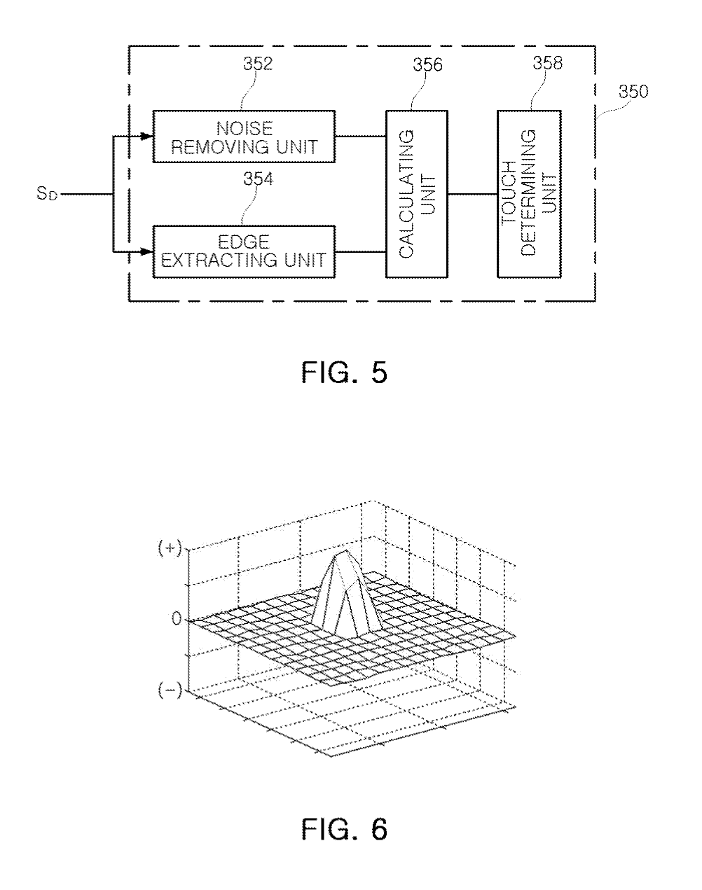

FIG. 5 is a block diagram illustrating a touch sensing unit according to an exemplary embodiment in the present disclosure, wherein the touch sensing unit 350 may include a noise removing unit 352, an edge extracting unit 354, a calculating unit 356, a touch determining unit 358. A method of removing noise according to the present exemplary embodiment will be described with reference to FIGS. 4 and 5.

Digital signals S_{D} transferred to the touch sensing unit 350 may include a plurality of digital data corresponding to levels of capacitance in the plurality of node capacitors C11 to Cmn, and as an example, the digital signal S_{D} may be obtained in a form as shown in FIG. 6. The digital signals S_{D} obtained by the touch sensing unit 350 may be generated from the changes in capacitance. In this case, the changes in capacitance may be generated by noise in addition to an active touch.

The noise removing unit 352 may remove components due to noise among the transferred digital signals S_{D}. As an example, the noise removing unit 352 may remove noise components from the digital signals by assuming that the noise components included in the digital signals S_{D} are distributed in a Gaussian form based on a peak value of the digital signal S_{D}.

The edge extracting unit 354 may extract edges of the digital signals S_{D}. According to an example, the edge extracting unit 354 may detect an envelope of the digital signals S_{D} and may use the detected envelope as the edges of the digital signal S_{D}.

The calculating unit 356 may generate a predetermined signal using the signal output from the noise removing unit 352 and the edges extracted by the edge extracting unit 354, and may provide the predetermined signal to the touch determining unit 358.

The signal output from the noise removing unit 352 corresponds to a signal from which components estimated as noise the digital signals S_{D} has been removed. Here, in the case in which the noise components have been removed from an original digital signal by assuming that noises are distributed in the Gaussian form based on the peak value of the digital signal S_{D}, the more noise components than the noise components which are actually present may be removed from digital data which is in the vicinity of the peak value and the noise components less than the noise components which are actually present may be removed from digital data which is not in the vicinity of the peak value.

In order to prevent the above-mentioned problems, the calculating unit 356 according to the present exemplary embodiment may reflect the edges output from the edge extracting unit 354 to the signal output from the noise removing unit 352 to generate a predetermined signal.

According to an exemplary embodiment in the present disclosure, the calculating unit 356 may perform an averaging operation for the signal output from the noise removing unit 352 and the edges output from the edge extracting unit 354. Alternatively, the calculating unit 356 may give different weights to the signal output from the noise removing unit 352 and the edges output from the edge extracting unit 354 and may then perform the averaging operation. In the case in which a larger weight is given to the signal output from the edge removing unit 352, this may mean that the removal of the noise components is focused, and in the case in which a larger weight is given to the edges output from the edge extracting unit 354, this may mean that the reserving of the digital signals S_{D} without distortion is focused.

The touch determining unit 358 may determine the touch according to the signal output from the calculating unit 356, and may determine at least one of the number, coordinates, and gesture operations of touches applied to the panel unit 310.

As set forth above, according to exemplary embodiments of the present disclosure, the edges of the digital signals are reflected to the digital signals from which the noise components have been removed, whereby the noise components may be effectively removed without distorting an original digital signal.

While exemplary embodiments have been shown and described above, it will be apparent to those skilled in the art that modifications and variations could be made without departing from the scope of the present invention as defined by the appended claims.

What is claimed is:

1. A touch sensing apparatus comprising:
a noise removing unit removing noise components from digital signals generated based on changes in capacitance;
an edge extracting unit extracting edges of the digital signals;
a calculating unit calculating an output signal of the noise removing unit and the edges output from the edge extracting unit; and
a touch determining unit determining a touch based on an output signal of the calculating unit.

2. The touch sensing apparatus of claim 1, wherein the noise removing unit removes noise components, distributed in a Gaussian form, from the digital signal.

3. The touch sensing apparatus of claim 1, wherein the edge extracting unit detects an envelope of the digital signal to extract the edges.

4. The touch sensing apparatus of claim 1, wherein the calculating unit performs an averaging operation for the output signal of the noise removing unit and the edges.

5. The touch sensing apparatus of claim 4, wherein the calculating unit performs the averaging operation by assigning different weights to the output signal of the noise removing unit and the edges.

6. The touch sensing apparatus of claim 1, wherein the touch determining unit determines at least one of the number, coordinates, and gesture operations of touches.

7. A touchscreen apparatus comprising:
a panel unit including a plurality of first electrodes and a plurality of second electrodes intersecting with the plurality of first electrodes; and
a touch sensing unit sensing a touch based on digital signals generated according to levels of capacitance in intersection points of the plurality of first electrodes and the plurality of second electrodes,
wherein the touch sensing unit determines the touch by calculating a first signal that noise components have been removed from the digital signals and a second signal along edges of the digital signals.

8. The touchscreen apparatus of claim 7, wherein the touch sensing unit includes:
a noise removing unit removing noise components from the digital signals to generate the first signal;
an edge extracting unit extracting the edges of the digital signal to generate the second signal;
a calculating unit calculating the first signal and the second signal; and
a touch determining unit determining the touch based on an output signal of the calculating unit.

9. The touchscreen apparatus of claim 8, wherein the noise removing unit removes noise components, distributed in a Gaussian form, from the digital signal.

10. The touchscreen apparatus of claim 8, wherein the edge extracting unit detects an envelope of the digital signal to extract the edges.

11. The touchscreen apparatus of claim 8, wherein the calculating unit performs an averaging operation for the first signal and the second signal.

12. The touchscreen apparatus of claim 11, wherein the calculating unit performs the averaging operation by assigning different weights to the first signal and the second signal.

13. The touchscreen apparatus of claim 7, further comprising a driving circuit unit applying a predetermined driving signal to the plurality of first electrodes.

14. The touchscreen apparatus of claim 7, further comprising a sensing circuit unit detecting the levels of capacitance from the plurality of second electrodes.

15. The touchscreen apparatus of claim 7, further comprising a signal converting unit performing an analog-digital conversion for the levels of capacitance to generate the digital signals.
